(19) United States
(12) Patent Application Publication
(10) Pub. No.: US 2025/0182956 A1
(43) Pub. Date: Jun. 5, 2025

(54) FOIL WINDING LEADS AND METHOD FOR FORMING THE SAME

(71) Applicants: ABB Schweiz AG, Baden (CH); Technische Universiteit Eindhoven, AE Eindhoven (NL)

(72) Inventors: Andrea Cremasco, AE Eindhoven (NL); Elena Lomonova, AE Eindhoven (NL); Daniel Rothmund, Mulligen (CH)

(21) Appl. No.: 18/980,093

(22) Filed: Dec. 13, 2024

Related U.S. Application Data
(63) Continuation of application No. PCT/NL2023/050344, filed on Jun. 21, 2023.

(30) Foreign Application Priority Data
Jun. 21, 2022 (NL) 2032236

(51) Int. Cl. H01F 27/32; H01F 27/24; H01F 41/06; H01F 41/12

(52) U.S. Cl. CPC H01F 27/32; H01F 27/24; H01F 41/06; H01F 41/12

(57) ABSTRACT

An insulated winding assembly comprising an insulated foil conductor comprising a lead-in section, a lead-out section and a winding section between the lead-in and lead-out sections, wherein in the winding section, the insulated foil conductor is wound around a core material to form windings, wherein each of the lead-in and lead-out section is folded with respect to the winding section and arranged transverse to the windings of the winding section, and wherein each of the lead-in and lead-out section comprises at least one folding cut along a lengthwise direction of the foil conductor, thereby forming at least two strips. A corresponding method and a transformer comprising such a winding assembly is also presented herein.

### CROSS-REFERENCE TO RELATED APPLICATIONS

This application is a continuation of, and claims priority to, International Patent Application No. PCT/NL2023/050344, filed Jun. 21, 2023 and titled “FOIL WINDING LEADS AND METHOD FOR FORMING SAME”, which claims priority to Patent Application No. 2032236, filed in the Netherlands on Jun. 21, 2022 and titled “FOIL WINDING LEADS AND METHOD FOR FORMING SAME”, each of which are hereby incorporated by reference in their entirety.

### TECHNICAL FIELD

The present disclosure generally relates to the field of electrical devices and more specifically to foil winding leads and methods for forming the same, for use, for example, in a transformer and an inductor.

### BACKGROUND

In the recent years, the need for highly efficient interfaces between the Medium-Voltage (MV) AC grid and Low-Voltage (LV) DC buses has significantly increased hand in hand with the rapidly growing amount of high-power LV DC loads and sources.

In such a scenario, the so-called Solid-State Transformers (SSTs), i.e., galvanically isolated high-power AC/DC and DC/DC converters, could replace the state-of-the-art technology based on Low-Frequency Transformers (LFTs), due to several benefits such as smaller volume and weight.

The power conversion in an SST is supported by transformers operating with MV Pulse Width Modulated, PWM, waveforms in the kilohertz range. Therefore, this category of transformer is called Medium-Frequency Transformer (MFT), see FIG. 1.

The coil of a typical MFT consists of an inner secondary winding (LV), connected to the low voltage side of the converter (<1.1 kV) and an outer primary winding (HV), radially stacked to LV and connected to the side of the converter with highest voltage. The coil is installed around the magnetic circuit of the MFT, which is normally grounded for safety. The upper half of the cross-section of the MFT is shown in FIG. 2.

The use of foil conductor for the winding of the MFT has gained interest, thanks to the reduced cost compared to litz wire. Two of the main limitations in the use of foil conductor is the ohmic loss behavior in presence of a magnetic field normal to the conductor and the manufacturing complexity to realize the winding leads (busbars) in presence of large winding and wide foils.

Several methods are found to realize the leads of a foil winding, as shown in the patents presented in the next part. An example of winding leads with 50 mm foil is shown in FIG. 3. In this case, the foil could be easily folded as shown in FIG. 3. In high power MFT the foil can exceed 200 mm, so the method shown in FIG. 3 is impractical.

US 2009/0302986 discloses an idea pertaining to realization of busbars, However, the main disadvantage is the reduction of the conductor cross section in correspondence with the leads.

U.S. Pat. No. 7,880,575 B2 proposes the realization of busbars by welding a layer of conductor. This does not result in an integral construction

US 2002/0057177 proposes certain modifications wherein a winding breakout is mechanically separate from the winding, such that an electrical junction is present. It also proposes a reduction in the conductor cross sectional area.

No method is found to reduce ohmic losses in the busbars of an MFT.

### BRIEF DESCRIPTION

A summary of aspects of certain examples disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects and/or a combination of aspects that may not be set forth.

In a first aspect of the present disclosure, there is presented an insulated winding assembly comprising an insulated foil conductor comprising a lead-in section, a lead-out section and a winding section between the lead-in and lead-out sections, wherein in the winding section, the insulated foil conductor is wound around a core material to form windings, wherein each of the lead-in and lead-out section is folded with respect to the winding section and arranged transverse to the windings of the winding section, and wherein each of the lead-in and lead-out section comprises at least one folding cut along a lengthwise direction of the foil conductor, thereby forming at least two strips.

Foil conductors are known to the person skilled in the art in the relevant technical field and are formed by a planar conductor that is insulated. The core material maybe any suitable material as required by the application. As an example, the core material may be air, or any suitable ferromagnetic material with a suitable permeability of magnetic field.

It was the insight of the inventors that by forming at least one folding cut on the foil conductor and folding the at least two strips thus formed in a transverse direction to the windings, the surface area exposed to the magnetic field in a perpendicular direction to the magnetic field is thus reduced. This has the advantage of reducing losses due to eddy currents.

As an advantage over the known prior art documents, the present disclosure achieves lesser loss without a reduction in the cross-sectional area of the conductor. This therefore ensures a higher current carrying capacity. As a further advantage, the present disclosure achieves forming a winding assembly without the need of any mechanical joining, such as welding, between the different elements. The winding assembly is thus formed integrally, ensures a higher current carrying capacity and lower losses due to eddy currents.

According to an example, the at least two strips are stacked one on top of the other. This can be achieved by for example, folding the at least two strips in a suitable fashion such that they can be stacked on top of one another.

According to an example, the insulated winding assembly further comprises a plurality of slits formed in each of the at least two strips in the lead-in and lead-out sections, wherein the plurality of slits are formed along a lengthwise direction. By providing further slits on the so formed strips, eddy currents can be further limited.

According to an example, the insulated winding assembly further comprises lugs in each of the lead-in and lead-out sections arranged to provide electrical connection to the insulated winding assembly with an external electrical component. Such lugs may be connected to each of the at least two strips, or may be connected to a stack formed by stacking the at least two strips on top of one another.

According to an example, each of the at least two strips have an equal width. This is one embodiment, wherein each of the at least two strips have an equal width. This ensures uniform current distribution over each of the strips.

According to an example, the at least two strips have different lengths such that after folding, the at least two strips terminate at a same line. This may be achieved, for example, by cutting off a small section of each subsequent strip such that the strips overlap with one another perfectly. The skilled person understands that such a choice helps in connecting the winding assembly to other components.

In a second aspect of the present disclosure, there is presented an electrical transformer comprising a primary and a secondary winding, wherein at least one of the primary or the secondary winding is an insulated winding assembly according to any of the examples of the first aspect of the present disclosure. In particular, such a winding assembly may be employed in solid state transformers that are gaining popularity in the power converters.

It is further noted that the definitions and advantages of the first aspect of the present disclosure being an insulated winding assembly are also associated with the second aspect of the present disclosure being the electrical transformer.

In a third aspect of the present disclosure, there is presented a method of forming an insulated winding assembly, wherein the insulated winding assembly is formed using a foil conductor having a lead-in section, a lead-out section and a winding section in between the lead-in and lead-out section, the method comprising the steps of providing at least one folding cut along a lengthwise direction of a foil conductor thereby forming at least two strips in each of the lead-in and lead-out section of the foil conductor; winding the winding section about a core material; and folding each of the lead-in and lead-out sections transverse to the windings of the winding section.

It is noted that the definitions and advantages of the first aspect of the present disclosure being an insulated winding assembly are also associated with the third aspect of the present disclosure being the method of forming the insulated winding assembly.

According to an example of the third aspect, after folding, the at least two strips are stacked one on top of the other.

According to an example of the third aspect, the method further comprises a step of forming a plurality of slits in each of the at least two strips in the lead-in and lead-out sections, wherein the plurality of slits are formed along a lengthwise direction.

According to an example of the third aspect, the method further comprises a step of providing lugs in each of the lead-in and lead-out sections to provide electrical connection to the insulated winding assembly with an external electrical component.

According to an example of the third aspect, the folding cuts are provided such that each of the at least two strips have an equal width.

According to an example of the third aspect, the at least two strips have different lengths such that after folding, the at least two strips terminate at a same line.

The present disclosure is described in conjunction with the appended figures. It is emphasized that, in accordance with the standard practice in the industry, various features are not drawn to scale. In fact, the dimensions of the various features may be arbitrarily increased or reduced for clarity of discussion.

In the appended figures, similar components and/or features may have the same reference label. If only the first reference label is used in the specification, the description is applicable to any one of the similar components having the same first reference label irrespective of the second reference label.

The above and other aspects of the disclosure will be apparent from and elucidated with reference to the examples described hereinafter.

### BRIEF DESCRIPTION OF THE DRAWINGS

FIG. 1 illustrates a prior art medium frequency transformer, MFT, with foil conductor.

FIG. 2 illustrates a cross section indicating the primary and secondary winding of a prior art transformer.

FIG. 3 illustrates a prior art 50 mm foil conductor MFT prototype with busbars folded to make the leads of the winding.

FIG. 4 illustrates an aspect of the present disclosure using a paper foil.

FIG. 5 illustrates a concept of the present disclosure when applied to a transformer.

### DETAILED DESCRIPTION

A more detailed description is made with reference to particular examples, some of which are illustrated in the appended drawings, such that the manner in which the features of the present disclosure may be understood in more detail. It is noted that the drawings only illustrate typical examples and are therefore not to be considered to limit the scope of the subject matter of the claims. The drawings are incorporated for facilitating an understanding of the disclosure and are thus not necessarily drawn to scale. Advantages of the subject matter as claimed will become apparent to those skilled in the art upon reading the description in conjunction with the accompanying drawings.

The ensuing description above provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment of the disclosure, it being understood that various changes may be made in the function and arrangement of elements, including combinations of features from different embodiments, without departing from the scope of the disclosure.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, electromagnetic, or a combination thereof. Additionally, the words “herein,” “above,” “below,” and words of similar import, when used in this application, refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list.

These and other changes can be made to the technology in light of the following detailed description. While the description describes certain examples of the technology, and describes the best mode contemplated, no matter how detailed the description appears, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the Detailed Description section explicitly defines such terms. Accordingly, the actual scope of the technology encompasses not only the disclosed examples, but also all equivalent ways of practicing or implementing the technology under the claims.

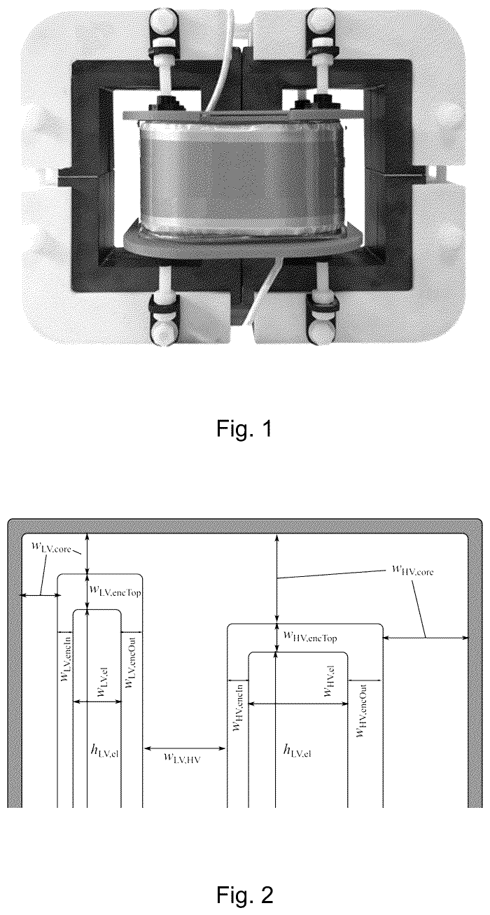

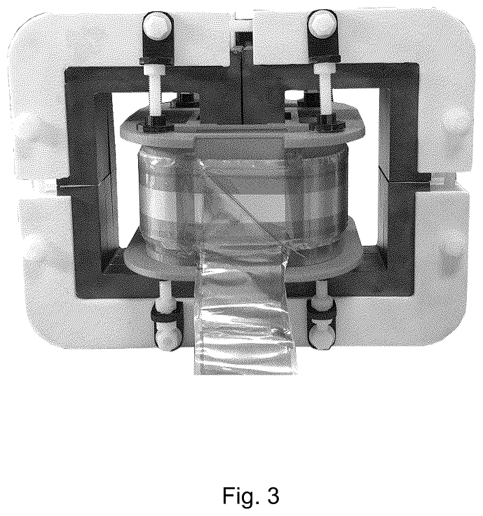

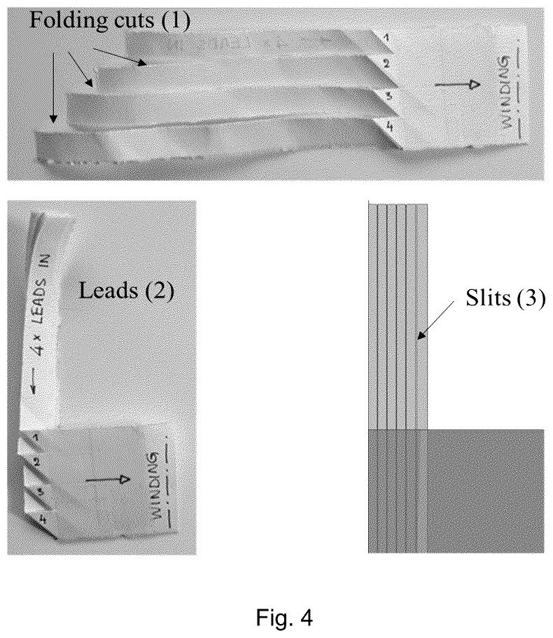

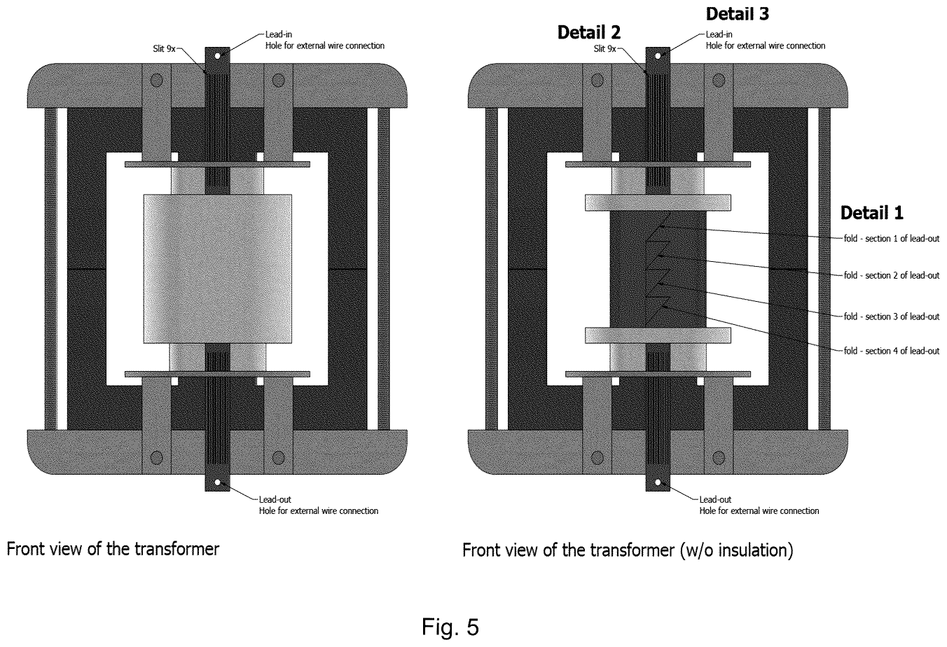

FIGS. 1-3 have already been cited and explained In the background section. The embodiments according to the present application is further elaborated with reference to FIGS. 4 and 5.

FIG. 4 illustrates an aspect of the present disclosure using a paper foil. It is understood that FIG. 4 does not show a complete foil conductor but merely shows a portion of it. It may be understood that FIG. 4 shows a section of the foil conductor starting from a lead-in section showing the folding cuts, and the folds being located transverse to the windings of the winding section. The windings themselves are not shown and also the lead-out section is also not shown.

The skilled person understands that a similar construction may be obtained at the other end of the foil conductor to obtain the lead-out section. Furthermore, a main objective of the disclosure according to the present disclosure is the reduction of losses in the busbar of an MFT which is achieved by the folding cuts and folding of the lead-in and/or lead-out section which is visualized in FIG. 4. The foil busbars are realized cutting the conductor as shown in (1). The resulting strips are folded as shown in (2). The individual conductors are insulated from each other. The foil is cut in several vertical slits (3).

The following benefits are achieved:

The cross-section area of the conductor is not reduced in contrast with the ideas presented in known prior art.

No welding is needed—in contrast with the idea presented in known prior art documents.

The surfaces crossed by the normal magnetic field is reduced. Proximity losses in the conductor drop. Results have also been confirmed by the same numerical model validated experimentally.

The slits (3) reduce further the circulating current caused by the normal magnetic field.

Although FIG. 4 suggest making 3 folding cuts to obtain 4 strips, the skilled person understands that this is shown merely for the purpose of demonstration. In a practical case, the number of cuts may be increased or decreased based on the required application or any other constraints. Furthermore, FIG. 4 in (1) shows that each of thus formed strips has a different length. This ensures that after folding, each of the strip overlap with one another such that the strips all terminate at a same line, as can be seen in (2), (3). This facilitates connection of the lead-in and/or lead-out section with other electrical components in an easy manner.

FIG. 5 illustrates a concept of the present disclosure when applied to a transformer.

Detail 1: a foil conductor cut in four sections or strips, folded 90° with respect to the foil axis;

Detail 2: each winding lead (in and out) is cut in nine slits, in correspondence with the regions of high transverse magnetic field;

Detail 3: each lead is terminated with a hole, for the electrical connection with the lugs of external cables—this is optional.

Although FIG. 5 suggests implementing four sections or strips and providing nine slits in the strips, the skilled person understands that these are merely exemplary and are not limiting in any manner.

1. An insulated winding assembly comprising:
an insulated foil conductor comprising a lead-in section, a lead-out section, and a winding section between the lead-in section and the lead-out section, wherein in the winding section, the insulated foil conductor is wound around a core material to form windings, wherein each of the lead-in section and the lead-out section is folded with respect to the winding section and arranged transverse to the windings of the winding section, and wherein each of the lead-in section and the lead-out section comprises:
at least one folding cut along a lengthwise direction of the insulated foil conductor, thereby forming at least two strips.

2. The insulated winding assembly according to claim 1, wherein the at least two strips are stacked one on top of the other.

3. The insulated winding assembly according to claim 1, further comprising a plurality of slits formed in each of the at least two strips in the lead-in section and the lead-out section, wherein the plurality of slits are formed along a lengthwise direction.

4. The insulated winding assembly according to claim 1, further comprising lugs in each of the lead-in section and the lead-out section configured to provide electrical connection to the insulated winding assembly with an external electrical component.

5. The insulated winding assembly according to claim 1, wherein each of the at least two strips have an equal width.

6. The insulated winding assembly according to claim 1, wherein the at least two strips have different lengths such that after folding, the at least two strips terminate at a same line.

7. An electrical transformer comprising a primary and a secondary winding, wherein at least one of the primary or the secondary winding is an insulated winding assembly according to claim 1.

8. A method of forming an insulated winding assembly, wherein the insulated winding assembly is formed using a foil conductor having a lead-in section, a lead-out section and a winding section in between the lead-in section and the lead-out section, the method comprising:
providing at least one folding cut along a lengthwise direction of the foil conductor, thereby forming at least two strips in each of the lead-in section and the lead-out section of the foil conductor;
winding the winding section about a core material; and
folding each of the lead-in section and the lead-out section sections transverse to the windings of the winding section.

9. The method according to claim 8, wherein after folding, the at least two strips are stacked one on top of the other.

10. The method according to claim 8, further comprising:
forming a plurality of slits in each of the at least two strips in the lead-in section and the lead-out section, wherein the plurality of slits are formed along a lengthwise direction.

11. The method according to claim 8, further comprising:
providing lugs in each of the lead-in section and the lead-out section to provide electrical connection to the insulated winding assembly with an external electrical component.

12. The method according to claim 8, wherein the at least one folding cut is provided such that each of the at least two strips have an equal width.

13. The method according to claim 8, wherein the at least two strips have different lengths such that after folding, the at least two strips terminate at a same line.

14. The insulated winding assembly according to claim 2, further comprising a plurality of slits formed in each of the at least two strips in the lead-in section and the lead-out section, wherein the plurality of slits are formed along a lengthwise direction.

15. The insulated winding assembly according to claim 14, further comprising lugs in each of the lead-in section and the lead-out section configured to provide electrical connection to the insulated winding assembly with an external electrical component.

16. The insulated winding assembly according to claim 15, wherein each of the at least two strips have an equal width.

17. The insulated winding assembly according to claim 16, wherein the at least two strips have different lengths such that after folding, the at least two strips terminate at a same line.

18. The method according to claim 9, further comprising:
forming a plurality of slits in each of the at least two strips in the lead-in section and the lead-out section, wherein the plurality of slits are formed along a lengthwise direction.

19. The method according to claim 18, further comprising:
providing lugs in each of the lead-in section and the lead-out section to provide electrical connection to the insulated winding assembly with an external electrical component.

20. The method according to claim 19, wherein the at least one folding cut is provided such that each of the at least two strips have an equal width.
